(19) United States
(12) Patent Application Publication
(10) Pub. No.: US 2024/0399964 A1
(43) Pub. Date: Dec. 5, 2024

(54) FRONT TRUNK

(71) Applicant: TOYOTA BOSHOKU KABUSHIKI KAISHA, Aichi-ken (JP)

(72) Inventors: Masahiro NAGANO, Aichi-ken (JP); Kai AIZAWA, Aichi-ken (JP)

(73) Assignee: TOYOTA BOSHOKU KABUSHIKI KAISHA, Aichi-ken (JP)

(21) Appl. No.: 18/664,746

(22) Filed: May 15, 2024

(30) Foreign Application Priority Data
Jun. 5, 2023 (JP) 2023-092095

(51) Int. Cl. B60R 5/02

(52) U.S. Cl. CPC B60R 5/02

(57) ABSTRACT

A vehicle front trunk includes a storing portion having a box shape that opens upward. The storing portion is disposed in front of a vehicular compartment and has a storing space therein. The storing portion includes a bottom wall and side walls extending upward from the bottom wall, and a through hole that is included in one of the bottom wall and the side walls and through which the storing space is communicated with an outer space outside the storing portion.

### CROSS REFERENCE TO RELATED APPLICATION

This application claims priority from Japanese Patent Application No. 2023-92095 filed on Jun. 5, 2023. The entire contents of the priority application are incorporated herein by reference.

### TECHNICAL FIELD

The present technology described herein relates to a front trunk of a vehicle.

### BACKGROUND

In a mid-engine car including a driving system such as an engine in a middle section of a vehicular body and a rear-engine car including an engine in a rear section of a vehicular body, a storing space (a front trunk, which is a so-called frunk) can be included in front of a vehicular compartment. Electric vehicles including a motor as a driving power source have been developed and such electric vehicles include front trunks. A frunk module that is configured as a main body to form a storing space of the front trunk is fixed to a vehicular body with a certain mounting structure.

### SUMMARY

However, with the above mounting structure, rainwater or water used for washing the vehicle may enter the storing space and may be stored therein. Rainwater may enter the storing space that is disposed in front of the vehicular compartment when a cover (a hood) covering the storing space is lifted up to be opened. Particularly, if the cover is configured not to be able to cover an opening of the storing space effectively with the cover being lifted up or the front section of a vehicle having particular shape, rainwater may be likely to enter the storing space. On the other hand, various noise such as wind noise caused under a vehicle floor or noise from tires or driving source are caused outside the frunk module. To provide a comfortable vehicular interior space, such noise needs to be reduced.

An object of the present technology described herein is to provide a front trunk with which water can be drained from a storing portion. Another object of the present technology described herein is to provide a front trunk with which noise caused outside the storing portion can be reduced.

A vehicle front trunk according to the technology described herein includes a storing portion having a box shape that opens upward. The storing portion is disposed in front of a vehicular compartment and has a storing space therein. The storing portion includes a bottom wall and side walls extending upward from the bottom wall, and a through hole that is included in one of the bottom wall and the side walls and through which the storing space is communicated with an outer space outside the storing portion. The bottom wall and the side walls define the storing space.

### BRIEF DESCRIPTION OF THE DRAWINGS

FIG. 1 is a perspective view of a vehicle according to a first embodiment.

FIG. 2 is a perspective view of a storing portion and a motor.

FIG. 3 is a cross-sectional view illustrating the storing portion and a cover taken along line III-III in FIG. 2.

FIG. 4 is a cross-sectional view illustrating a storing portion and the cover according to a second embodiment taken along line IV-IV in FIG. 5.

FIG. 5 is a perspective view of the storing portion according to the second embodiment.

FIG. 6 is a perspective view of a storing portion of a modification of the second embodiment.

FIG. 7 is a cross-sectional view illustrating a storing portion and the cover according to a third embodiment.

FIG. 8 is a cross-sectional view illustrating a storing portion and the cover according to a fourth embodiment.

### DETAILED DESCRIPTION

### First Embodiment

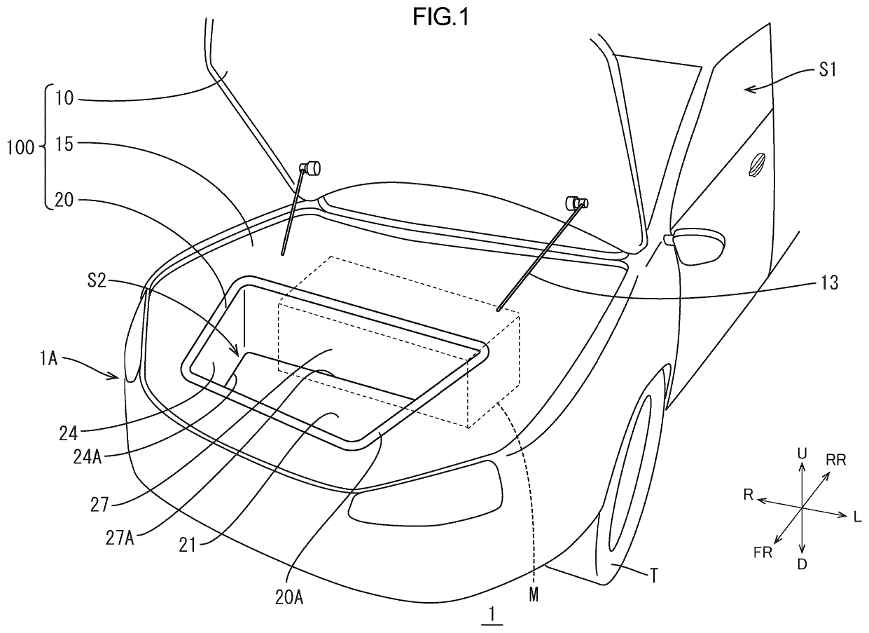

A front trunk 100 of a vehicle 1 according to a first embodiment of the present disclosure will be described with reference to FIGS. 1 to 3. In each of the drawings, arrows FR and RR represent a front side and a rear side, respectively, arrows U and D represent a lower side and a left side, respectively, and arrows L and R represent a left side and a right side, respectively. A right-left direction corresponds to a vehicular width direction.

As illustrated in FIG. 1, the vehicle 1 includes a vehicular compartment S1 and a front section 1A that is in front of the vehicular compartment S1. The vehicular compartment S1 is an interior space in which passengers get in. The front section 1A projects frontward from the vehicular compartment S1. Tires T, a motor M that is a driving source for rotating the tires T to move the vehicle 1, and the front trunk 100 are included in the front section 1A. The tires T are included in both side sections of the front section 1A with respect to the vehicular width direction. The tires T and the motor M create noise when the vehicle 1 is running. The vehicle 1 is an electric automobile and an engine that is a driving source for moving the vehicle 1 is not installed in the vehicle 1.

The front trunk 100 is above the tires T and the motor M. The front trunk 100 includes abase member 15, a cover 10 (a hood), and a storing portion 20. The base member 15 is a wall extending in a vehicular front-rear direction and the vehicular width direction. The storing portion 20 is a recess in a middle of the base member 15 and opens upward. The cover 10 is disposed above the base member 15 and covers an opening of the storing portion 20. The cover 10 is configured to be lifted up to uncover the opening.

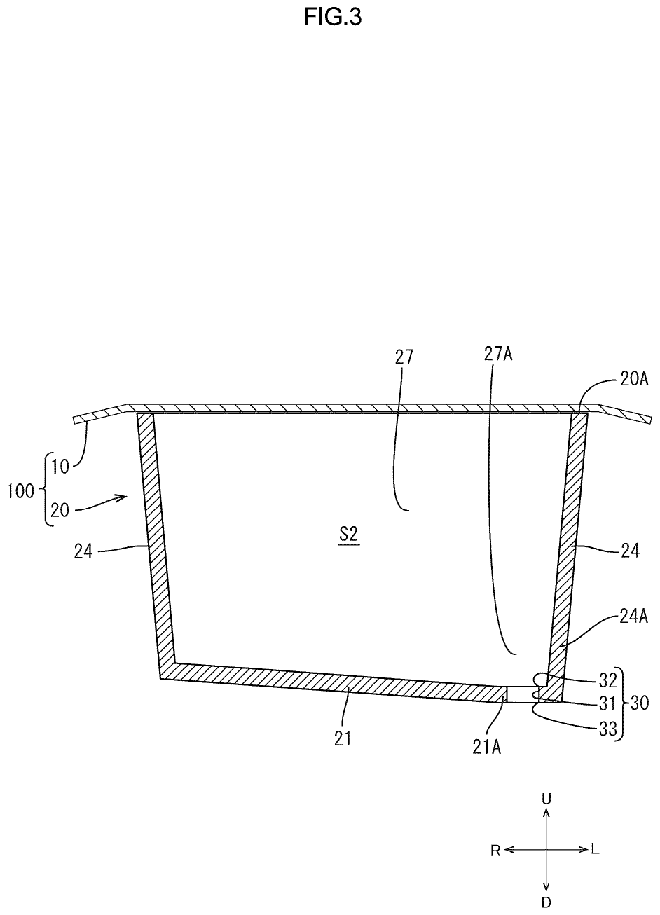

When the cover 10 is lifted up from the base member 15 and opens the opening of the storing portion 20, the cover 10 is in an open state as illustrated in FIG. 1. When the cover is disposed opposite the base member 15 and closes the opening of the storing portion 20, the cover 10 is in a closed state as illustrated in FIG. 3. The cover 10 is configured to be movable between the closed state and the open state. In the open state, support members 13 extend from the base member 15 to the cover 10 to support the cover 10 that is in the open state. In the closed state, the opening of the storing portion 20 is covered with the cover 10 and a storing space S2 in the storing portion 20 is defined by the cover 10. Luggage is stored in the storing space S2. An opening edge 20A of the storing portion 20 is an elastic portion having elasticity and is formed from material softer than that of the base member 15. The storing portion 20 can be closely contact with the cover 10 via the elastic portion when the cover 10 is in the closed state.

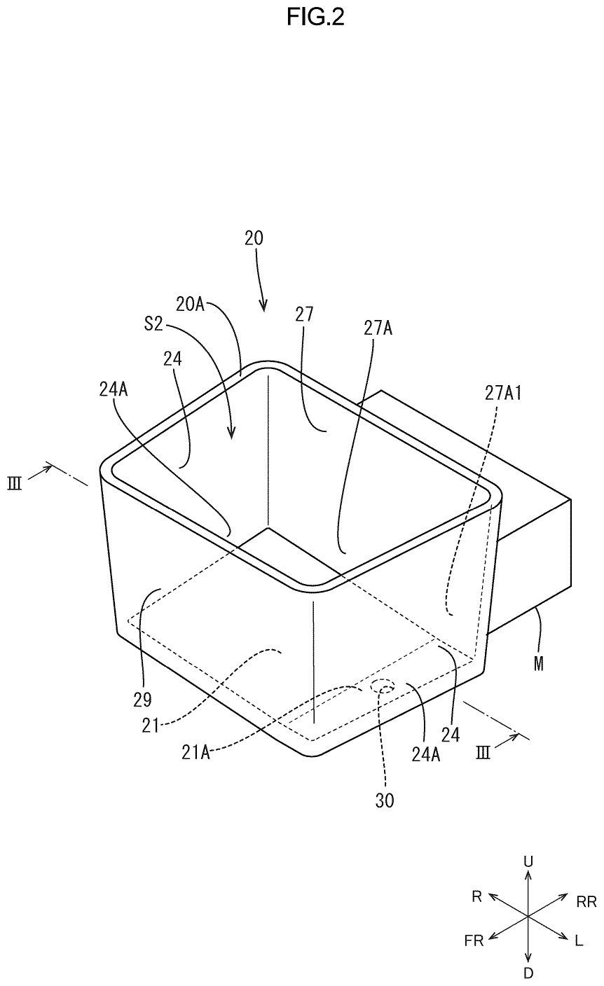

The storing portion 20 is on a front side with respect to the vehicular compartment S1 and recessed downward. As illustrated in FIGS. 2 and 3, the storing portion 20 includes a bottom wall 21 and side walls. The bottom wall 21 is a rectangular plate that extends in the front-rear direction and the right-left direction. The side walls include two side walls 24, a rear wall 27, and a front wall 29. The side walls 24 extend upward from side edges of the bottom wall 21 with respect to the width direction, respectively, and are opposite each other. Each of the side walls 24 is a rectangular plate that extends in the front-rear direction and the upper-bottom direction. The side walls 24 are configured as walls of the storing portion 20 that are disposed opposite each other with respect to the vehicular width direction. The rear wall 27 extends upward from a rear edge of the bottom wall 21 and is a rectangular plate that extends in the vehicular width direction and the upper-bottom direction. The rear wall 27 is configured as a rear wall of the storing portion 20. The front wall 29 extends upward from a front edge of the bottom wall 21 and is a rectangular plate that extends in the vehicular width direction and the upper-bottom direction. The front wall 29 is configured as a front wall if the storing portion 20. The front wall 29 and the rear wall 27 are opposite each other with respect to the front-rear direction. The storing portion 20 includes a storing space S2 that is defined by the bottom wall 21, the side walls 24, the rear wall 27, and the front wall 29. The motor M is disposed behind the rear wall 27 (on an outer side with respect to the rear wall 27).

A skin having a sound absorbing property may be attached to surfaces of the walls 21, 24, 27, 29 that face the storing space S2. Material of such a skin is not limited to a particular one but may be non-woven fabric and woven fabric.

Upper edges of the side walls 24, the rear wall 27, and the front wall 29 are defined as the opening edge 20A. The bottom wall 21 includes a left edge portion 21A. The two side walls 24 and the rear wall 27 include lower edge portions 24A, 27A, respectively. The left edge portion 21A of the bottom wall 21 is connected to the lower edge portion 24A of the left side wall 24. The lower edge portion 24A corresponds to a base portion. The bottom wall 21 includes a through hole 30 in a middle of the left edge portion 21A with respect to the front-rear direction. The through hole 30 extends through the bottom wall 21 in the upper-bottom direction, which is a thickness direction of the bottom wall 21 or an inner-outer direction of the storing portion 20. As illustrated in FIG. 3, the bottom wall 21 is inclined downward as it extends toward the through hole 30.

The through hole 30 is a circular hole. As illustrated in FIG. 3, the through hole 30 has a tubular inner surface 31 extending in the upper-bottom direction, an inner opening 32, and an outer opening 33. The inner opening 32 is at an upper end of the through hole 30 and at an upper end of the tubular inner surface 31 and opens toward the storing space S2 or an inner side of the storing portion 20. The outer opening 33 is at a lower end of the through hole 30 and at a lower end of the tubular inner surface 31 and opens toward an outer space or an outer side of the storing portion 20. The storing space S2 of the storing portion 20 communicates with the outer space through the through hole 30. The outer space may be a space that is an inner space of the front section 1A of the vehicle 1 and in which the motor M is disposed or may be an outer space that is outside the vehicle such as a space in which the tires T are disposed and a space under a floor. When noise occurs in the outer space, air resonance is caused in the storing portion 20 by the noise via the through hole 30 (Helmholts resonance). Accordingly, the noise caused in the outer space can be absorbed and reduced.

Next, effects of this embodiment will be described. The front trunk 100 of the vehicle 1 according to this embodiment includes the storing portion 20 that is disposed on a front side with respect to the vehicular compartment S1 and opens upward. The opening of the storing portion 20 is covered by the cover 10 and the storing portion 20 has the storing space S2 therein. The storing portion 20 includes the bottom wall 21, the side walls 24, and the rear wall 27. The side walls 24 extend upward from the bottom wall 21 and are opposite each other with respect to the vehicular width direction. The rear wall 27 extends upward from the bottom wall 21 and is configured as a rear side wall of the storing portion 20. The bottom wall 21 includes the through hole 30 that extends through the bottom wall 21 in the inner-outer direction of the storing portion 20.

According to such a front trunk 100, with the storing portion 20, which is disposed on the front side with respect to the vehicular compartment S1 and in which luggage can be stored, and the through hole 30, noise that is caused outside the storing portion 20 can be absorbed and reduced. Namely, the storing portion 20 and the through hole 30 are configured as a resonator. With the bottom wall 21 including the through hole 30, wind noise that occurs under the floor of the vehicle 1 can be effectively absorbed with the air in the storing space S2 of the storing portion 20. Accordingly, a comfortable vehicular interior space can be provided. With the through hole 30 being included in the bottom wall 21, if water enters the storing portion 20, the water can be drained out of the storing portion 20 through the through hole 30. Since the bottom wall 21 is inclined downward as it extends toward the through hole 30, water is likely to flow toward the through hole 30 and can be drained through the through hole 30 effectively.

The motor M, which is a driving power source for the vehicle 1, is disposed outside the storing portion 20 and is behind the rear wall 27.

According to such a front trunk 100, noise caused by the motor M can be effectively absorbed with the storing portion 20.

### Second Embodiment

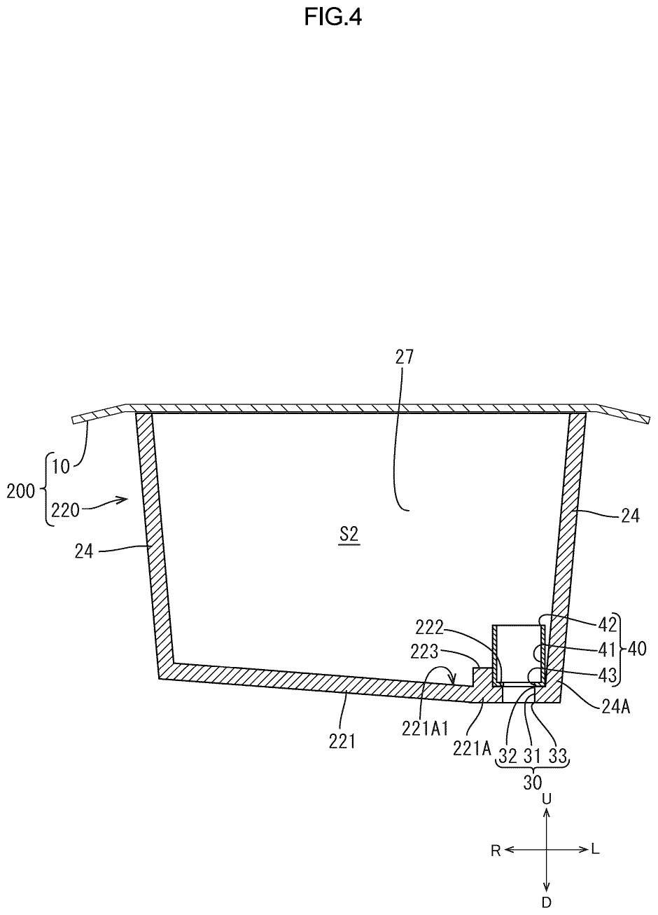

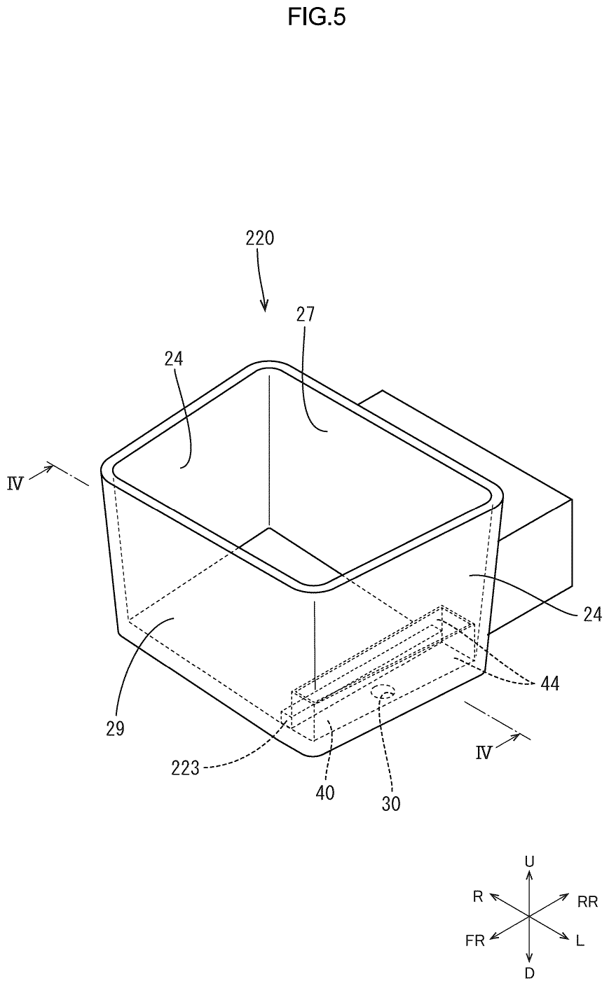

A front trunk 200 according to a second embodiment of the present disclosure will be described with reference to FIGS. 4 and 5. The same symbols are used for the components of the second embodiment that are same as those of the first embodiment. Configurations, operations, and effects that are same as those of the first embodiment will not be described.

The front trunk 200 includes a storing portion 220. The storing portion 220 includes a bottom wall 221 and a protrusion 223 that projects upward from a surface 221A1 of the bottom wall 221. The protrusion 223 projects from a left edge portion 221A of the bottom wall 221. The protrusion 223 is adjacent to one of the side walls 24 and adjacent to the through hole 30. The protrusion 223 is adjacent to an inner-side opening edge 222 of the inner opening 32 of the through hole 30. As illustrated in FIG. 5, the protrusion 223 has an elongated shape and extends along and between the front wall 29 and the rear wall 27. Specifically, the protrusion 223 extends from the front wall 29 to the rear wall 27.

According to such a front trunk 200, luggage stored in the storing portion 220 is stopped by the protrusion 223 so as not to fall into the through hole 30.

The storing portion 220 includes a hollow member 40. The hollow member 40 includes a hollow body portion 41 extending in the upper-bottom direction. The hollow body portion 41 has a box shape opening upward. The hollow body portion 41 includes a first hole 42 at an upper end of the hollow body portion 41 and a second hole 43 at a low end of the hollow body portion 41. The first hole 42 opens toward the storing space S2 and the second hole 43 opens downward. The first hole 42 corresponds to an opening of the hollow member 40 that opens upward. The second hole 43 is continuous to the through hole 30 of the bottom wall 221. The second hole 43 is connected to the inner opening 32 of the through hole 30. The second hole 43 is in a bottom of the hollow body portion 41. The hollow body portion 41 includes side walls 44 extending along one of the side walls 24 and opposite each other. The hollow body portion 41 extends between the front wall 29 and the rear wall 27. Specifically, the hollow body portion 41 extends from the front wall 29 to the rear wall 27. Namely, the side walls 44 extends from the front wall 29 to the rear wall 27. The hollow member 40 is contacted with the protrusion 223 and positioned securely. Specifically, one of the side walls 44 is contacted with the protrusion 223.

According to such a front trunk 200, a tool can be put inside the hollow member 40. For example, a jack can be arranged inside the hollow member 40 such that the hollow member 40 can be used as a tool box. By appropriately changing the length of the hollow member 40 extending in the upper-bottom direction or the size of the hollow member 40, the frequency of noise that can be absorbed with air in the storing space S2 of the storing portion 220 can be changed. A drain path for draining water through the through hole 30 may be formed on the surface of the bottom wall 221. The drain path may extend along or through the protrusion 223 or the hollow member 40.

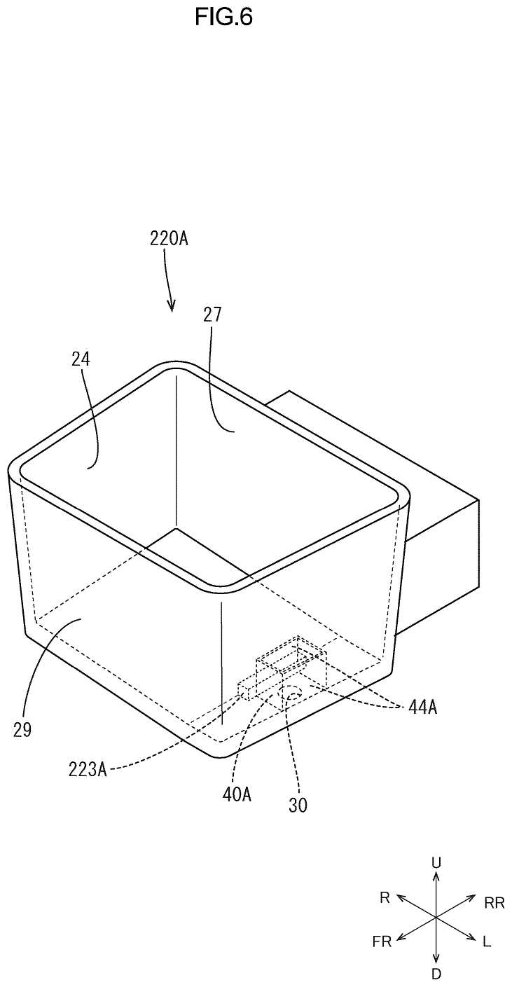

As illustrated in FIG. 6, a storing portion 220A according to a modification of the second embodiment includes a protrusion 223A. The protrusion 223A has a length extending along the side wall 24 that is smaller than the length of the protrusion 223. The protrusion 223A extends corresponding to the through hole 30. The storing portion 220A includes a hollow member 40A. The hollow member 40A includes side walls 44A that extend along one of the side walls 24 of the storing portion 220A. The hollow member 40A extends between the front wall 29 and the rear wall 27. The length of the hollow member 40A extending along the side wall 24 is smaller the length of the hollow member 40. Namely, the length of the side walls 44A is smaller than the length of the side walls 44. The side walls 44A extend opposite each other and sandwich the through hole 30. The side walls 44A, a front wall, and a rear wall of the hollow member 40A surround the through hole 30. The operations and effects similar to those of the second embodiment can be obtained in this modification. As illustrated in FIG. 4, the bottom wall 221 is inclined downward as it extends toward the through hole 30. With such a configuration, water that may enter the storing space S2 is likely to flow toward the through hole 30 and can be drained through the through hole 30 effectively.

### Third Embodiment

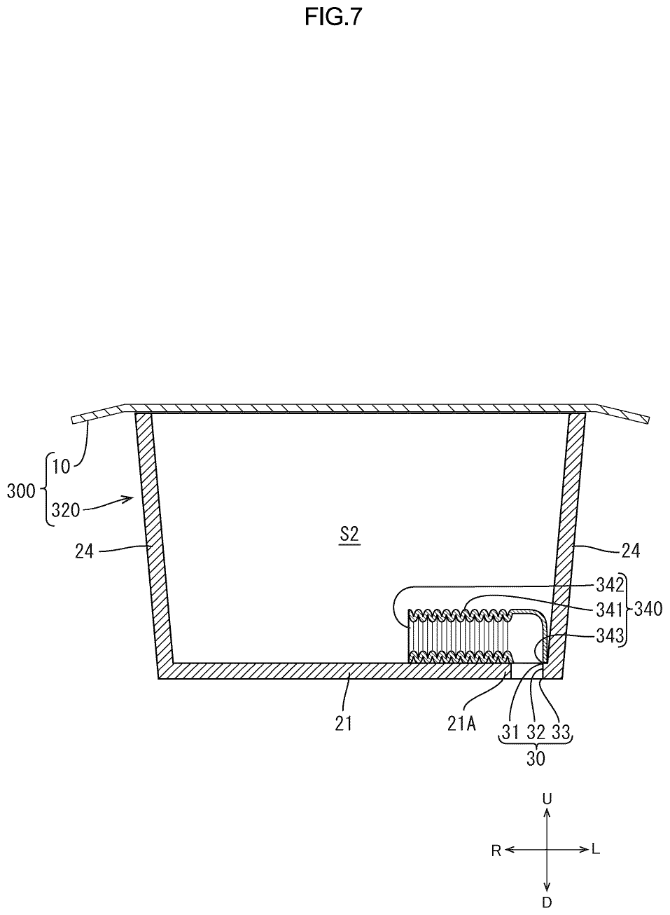

Next, a front trunk 300 according to a third embodiment of the present disclosure will be described with reference to FIG. 7. The same symbols are used for the components of the third embodiment that are same as those of the above embodiments. Configurations, operations, and effects that are same as those of the above embodiments will not be described.

The front trunk 300 includes a storing portion 320. The storing portion 320 includes a hollow member 340. The hollow member 340 includes a hollow body portion 341 extending in the vehicular width direction. The hollow body portion 341 is expandable and contractable in the vehicular width direction. The hollow member 340 includes a first hole 342 at a right end thereof and a second hole 343 at a left lower end thereof. The first hole 342 opens toward the storing space S2 of the storing portion 320 and the second hole 343 opens downward. The second hole 343 is continuous to the through hole 30 of the bottom wall 21. The second hole 343 is connected to the inner opening 32 of the through hole 30. The hollow body portion 341 is between the first hole 342 and the second hole 343. The hollow body portion 341 has a tubular shape with bellows. A radial cross-sectional shape of the hollow body portion 341 is not particularly limited and may be a square, a circle, or an indeterminate shape.

According to such a front trunk 300, by expanding and contracting the hollow body portion 341, the frequency of noise that can be absorbed with air in the storing space S2 can be changed easily.

### Fourth Embodiment

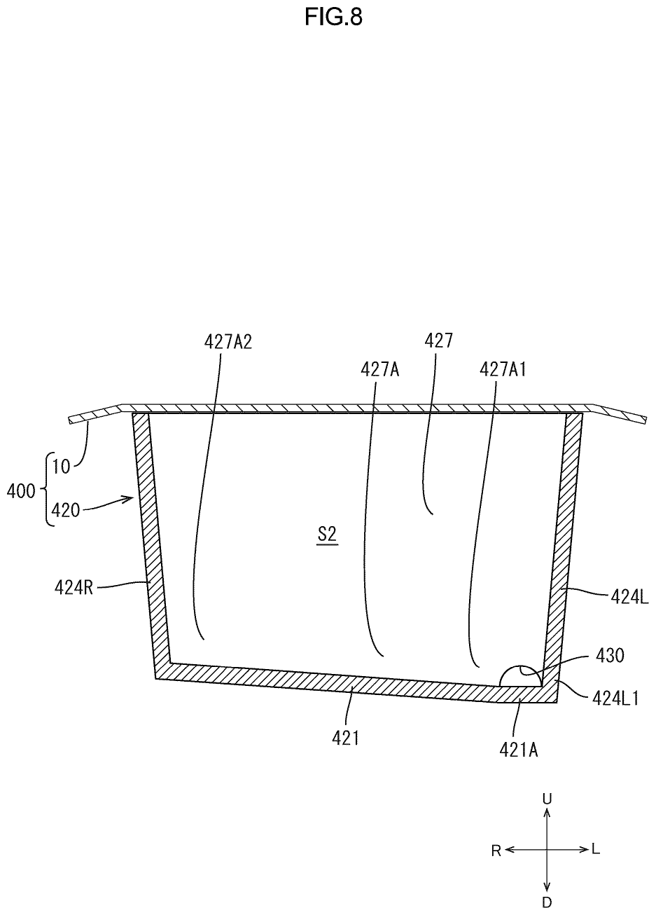

Next, a front trunk 400 according to a fourth embodiment of the present disclosure will be described with reference to FIG. 8. The same symbols are used for the components of the fourth embodiment that are same as those of the above embodiments. Configurations, operations, and effects that are same as those of the above embodiments will not be described.

The front trunk 400 includes a storing portion 420. The storing portion 420 includes a bottom wall 421 and walls extending from the bottom wall 421. The walls include two side walls 424R, 424L, which extend from two side edges of the bottom wall 421 with respect to the vehicular width direction, a rear wall 427, and a front wall. The side walls 424R, 424L are opposite each other with respect to the vehicular width direction. The rear wall 427 extends upward from a rear edge of the bottom wall 421 and the front wall extends upward from a front edge of the bottom wall 421. The rear wall 427 and the front wall are opposite each other with respect to the front-rear direction. A length of the left side wall 424L extending in the upper-bottom direction is greater than a length of the right side wall 424R. The rear wall 427 includes a left side corner portion 427A1 and a right side corner portion 427A2 in a lower edge portion 427A. The corner portion 427A1 is connected to a lower edge portion 424L1 of the left side wall 424L and a left edge portion 421A of the bottom wall 421. The corner portion 427A2 is connected to a lower edge portion of the right side wall 424R and a right edge portion of the bottom wall 421. The rear wall 427 includes a through hole 430 in the corner portion 427A1. The through hole 430 is through the rear wall 427 in the front-rear direction (the inner-outer direction of the storing portion 420). The through hole 430 is a semicircular hole. The bottom wall 421 is inclined downward as it extends leftward (toward the through hole 430). Therefore, the corner portion 427A1 is lower than the corner portion 427A2.

According to such a front trunk 400, with the rear wall 427 including the through hole 430, noise caused by the component that is disposed outside the rear wall 427 can be absorbed effectively with air inside the storing space S2. With the through hole 430 being formed in the corner portion 427A1 of the lower edge portion 427A of the rear wall 427, water that enters the storing portion 420 can be drained to the outside of the storing portion 429 through the through hole 430. Furthermore, the bottom wall 421 is inclined downward as it extends toward the through hole 430 and therefore, the water is effectively drained through the through hole 430.

### Other Embodiments

The technology described herein is not limited to the embodiments described above with reference to the drawings. The technology described herein may be modified within the technical scope. The following embodiments may be included in the technical scope.

The position or the shape of the through hole in the bottom wall or the rear wall may be altered as appropriate. For example, the through hole may be in a lower edge portion of the side wall. In such a configuration, noise caused by rotating tires can be effectively absorbed with air in the storing space S2 The through hole may be in a connection portion (a border portion) of the bottom wall and the side wall or a connection portion (a border portion) of the bottom wall and the rear wall. The shape of the through hole may be a square, a rectangle, a triangle, or an indeterminate shape.

The skin bonded to the surface of the walls of the storing portion may cover the through hole. In such a configuration, the portion of the skin covering the through hole may be made of material having breathability and water permeability (for example, mesh material). Accordingly, the storing portion is configured to exert a function of a resonator with preventing luggage falling in the through hole.

A noise generator other than the motor may be disposed in the space outside the storing portion. Examples of such noise generators may include various devices that generate noise such as an engine and a compressor of an air conditioner.

The configuration of the vehicle is not particularly specified. The vehicle may include an engine as a driving power source or may not include a motor. Such a driving power source may be arranged in a middle section or a rear section of a vehicle.

The front trunk described in the above embodiments may not be necessarily included in an automobile but may be included in various kinds of vehicles. Examples of the vehicles may be vehicles running on the ground such as a train and an amusement vehicle, flying vehicles such as an airplane and a helicopter, and vehicles on and in the sea such as a ship, and a submarine.

1. A vehicle front trunk comprising:
a storing portion having a box shape that opens upward, the storing portion being disposed in front of a vehicular compartment and having a storing space therein, the storing portion including
a bottom wall and side walls extending upward from the bottom wall, the bottom wall and the side walls defining the storing space, and
a through hole that is included in one of the bottom wall and the side walls and through which the storing space is communicated with an outer space outside the storing portion.

2. The vehicle front trunk according to claim 1, wherein
the through hole is included in one of the bottom wall and a lower edge portion of one of the side walls, and
the bottom wall is inclined downward as it extends toward the through hole.

3. The vehicle front trunk according to claim 1, wherein the through hole is in the bottom wall.

4. The vehicle front trunk according to claim 1, wherein the through hole is in a lower edge portion of one of the side walls.

5. The vehicle front trunk according to claim 3, wherein the storing portion includes a protrusion protruding from the bottom wall and being adjacent to the through hole.

6. The vehicle front trunk according to claim 3, wherein
the storing portion further includes a hollow member that is disposed above the through hole, and
the hollow member has a first hole that opens toward the storing space of the storing portion and a second hole that is connected to the through hole.

7. The vehicle front trunk according to claim 6, wherein the hollow member includes a hollow body portion between the first hole and the second hole and the hollow body portion is expandable and contractable.

8. The vehicle front trunk according to according to claim 1, wherein
the side walls include two side walls that are opposite each other with respect to a vehicular width direction, a front wall, and a rear wall, and
a motor for moving a vehicle is disposed outside the rear wall of the storing portion.

9. The vehicle front trunk according to claim 2, wherein the through hole is in the bottom wall.

10. The vehicle front trunk according to claim 2, wherein the through hole is in the lower edge portion of one of the side walls.

11. The vehicle front trunk according to claim 5, wherein
the side walls include two side walls that are opposite each other with respect to a vehicular width direction, a front wall, and a rear wall, and
the protrusion extends along one of the two side walls.

12. The vehicle front trunk according to claim 11, wherein the protrusion extends from the front wall to the rear wall.

13. The vehicle front trunk according to claim 6, wherein
the storing portion includes a protrusion protruding from the bottom wall and being adjacent to the through hole, and
the hollow member is between one of the side walls and the protrusion.
